(19) United States
(12) Patent Application Publication
(10) Pub. No.: US 2026/0300008 A1
(43) Pub. Date: Oct. 1, 2026

(54) NATIVE NODE REPAIR

(71) Applicant: Oracle International Corporation, Redwood Shores, CA (US)

(72) Inventors: Tanya Bansal, Seattle, WA (US); Guilin Mei, Bellevue, WA (US); Hui Ding, Issaquah, WA (US); Mickey Rocket Boxell, Chicago, IL (US); Hong Zhang, Westford, MA (US); Daniel Christopher Berg, Cary, NC (US)

(73) Assignee: Oracle International Corporation, Redwood Shores, CA (US)

(21) Appl. No.: 19/090,148

(22) Filed: Mar. 25, 2025

(51) Int. Cl. G06F 9/50

(52) U.S. Cl. CPC G06F 9/5027

(57) ABSTRACT

Techniques may include receiving, by a cluster management system, a ruleset that defines a node operation and a condition to trigger the node operation. The techniques can further include receiving, by the cluster management system, a node identifier and a label for a node identified by the node identifier. The techniques can further include responsive to receiving the node identifier and the label, transmitting, by the cluster management system and to a service provider system, a request to perform an operation with respect to a containerized application that is executing on one or more computing devices, wherein the containerized application is one of a plurality of containerized applications that are executing on the one or more computing devices, and wherein the containerized application is identified by the node identifier.

### BACKGROUND

Cluster architectures can allow for scalable deployment of computing resources. The cluster can allocate containerized workloads to nodes within the cluster, and the cluster can provide the nodes with the appropriate resources for executing the workload. Sometimes a node malfunctions and needs repairing. Improvements to processes for repairing nodes are desirable.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, techniques may include receiving, by a service provider computing system and from a tenant client, a request to perform an operation with respect to a containerized application that is executing on one or more computing devices wherein the request comprises a cluster identifier and a node identifier that identifies a node, wherein the containerized application is one of a plurality of containerized applications that are executing on the one or more computing devices, and wherein the containerized application is identified by the cluster identifier and the node identifier; providing, by the service provider computing system, a request to protect a workload of the node to the one or more computing devices identified by the cluster identifier and the node identifier; and providing, by the service provider computing system, a command to the node to cause the node to be repaired.

In one general aspect, techniques may include receiving, by a cluster management system, a ruleset that defines a node operation and a condition to trigger the node operation; receiving, by the cluster management system, a node identifier and a label for a node identified by the node identifier; and responsive to receiving the node identifier and the label, transmitting, by the cluster management system and to a service provider system, a request to perform an operation with respect to a containerized application that is executing on one or more computing devices, wherein the containerized application is one of a plurality of containerized applications that are executing on the one or more computing devices, and wherein the containerized application is identified by the node identifier.

Implementations of the described techniques may include hardware, a method or process, or a non-transitory computer tangible medium.

### BRIEF DESCRIPTION OF THE DRAWINGS

FIG. 1 shows a simplified diagram of a node repair system, according to at least one embodiment.

FIG. 2 shows a simplified diagram of a node repair system, according to at least one embodiment.

FIG. 3 shows a simplified flow diagram for processing performed by a node repair system, according to various embodiments.

FIG. 4 is a block diagram illustrating an example method for repairing a node, in accordance with at least one embodiment.

FIG. 5 shows a simplified diagram of a node repair system, according to at least one embodiment.

FIG. 6 shows a simplified flow diagram for processing performed by a node repair system, according to various embodiments.

FIG. 7 is a block diagram illustrating an example method for repairing a node, in accordance with at least one embodiment.

FIG. 8 shows a simplified diagram of a computer according to at least one embodiment.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud service provider may operate a cloud service provider infrastructure. The cloud service provider may offer a container service (e.g., Kubernetes, Docker, etc.) for managing, orchestrating, and/or scaling containerized software applications. A tenant (e.g., a customer) of the cloud service provider who uses the cloud service provider infrastructure to use the container service may run workloads on large container clusters with many nodes (e.g., thousands of nodes). In certain embodiments, the container clusters are Kubernetes clusters. Tenants can encounter hardware and/or software issues on a few of the nodes, which can slow down the application running on the nodes. The tenant typically uses a tenant client to isolate the faulty nodes using an API for the container service, followed by exploring maintenance actions (e.g., repair actions) by directly interfacing with a compute API of the cloud service provider infrastructure. The compute API may not be aware of the container service and/or the API for the container service (e.g., the compute API may not be capable of performing Kubernetes actions like cordon and drain, each described in further detail herein, to ensure workloads are moved to different nodes before performing a repair action). Additionally, tenants may have to perform special handling to ensure that after the node is repaired, the node re-joins the container cluster with the same node labels as before.

Certain embodiments described herein describe novel cloud service provider infrastructure APIs that allow customers to take various maintenance actions on nodes that are aware of the container service configurations including pod eviction settings (e.g., settings to control how and when pods are forcibly removed from a node due to various conditions such as resource pressure, node maintenance, and/or policy enforcement). Operations like reboot and boot volume replace (BVR) may be supported with built-in support for cordoning the node, draining the pods on the node, and waiting for a configurable graceful eviction duration before the node action is triggered. In certain embodiments, tenants can opt-into a forceful node action (e.g., an operation that forcefully affects a node state, often disrupting workloads of the node. These actions can include forcibly draining, shutting down, deleting, and/or removing a node from the cluster) if all pods are not gracefully evicted within the configured duration. After a node is repaired, the container service can ensure the node rejoins the container cluster while preserving the node labels present on the node before the repair. To allow preservation of the node labels, the container service may retain the node object in a data store (e.g., a control data store, and/or a key-value store like a distributed key-value store (etcd), etc.) while the node repair is in progress.

In certain embodiments, a bootstrap token can be re-issued as part of re-joining the node to the cluster after the maintenance action takes place. The bootstrap token may be re-issued if a corresponding in-progress boot volume replacement action is found for the same node in a work request bucket (e.g., a control data store, a node cell data store). The re-issued bootstrap token can protect against a security vulnerability where spurious nodes might join the cluster using a bootstrap token issued to existing member nodes. The bootstrap token may be issued to a node after the node has had a boot volume replacement. The bootstrap token may not need to be reissued to the node after a reboot has occurred because the node may still retain a previously issued bootstrap token.

Certain embodiments enable other improvements over traditional approaches by enabling a native container API (e.g., a Kubernetes API) to be used by tenants to manage and operate nodes. The native container API can eliminate the need for tenants to switch between using native container APIs and service provider infrastructure APIs to manage and operate nodes. The native container API can enable tenants to perform compute instance maintenance actions like reboot, boot volume replacement and instance replacement via native container APIs. The cluster operator may simply label faulty nodes with pre-configured container node labels (e.g., Kubernetes node labels) as a signal to the container service to safely trigger maintenance actions that correspond to the pre-configured container node labels. Embodiments can further enable tenants to define a maintenance action, criteria under which the maintenance action is to be triggered, along with configurations like pod eviction settings and maximum concurrency. The supported maintenance actions may include reboot, boot volume replacement, and/or instance replacement. These embodiments and improvements, along with others, are described herein in further detail.

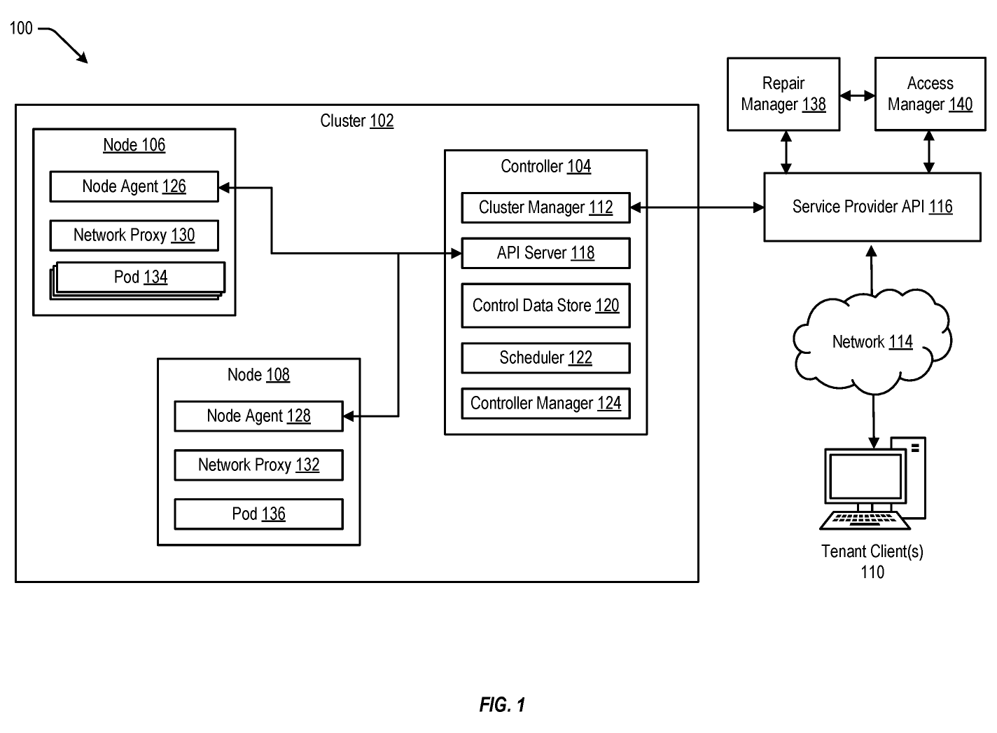

FIG. 1 shows a simplified diagram of a node repair system 100, according to at least one embodiment. The node repair system may include one or more tenant clients 110, a network 114, a service provider application programming interface (API) 116, a repair manager 138, an access manager 140, and a cluster 102. The controller may include a cluster manager 112, an API server 188, a control data store 120, a scheduler 122, and/or a controller manager 124. Cluster 102 can include a controller 104 and one or more nodes (e.g., node 106 and node 108). The controller 104 and the one or more nodes 106 and 108 are computing devices, and, while two nodes are shown in node repair system 100, the cluster 102 can include any number of nodes.

The cluster 102 can receive a node maintenance request from the tenant clients 110 at the cluster manager 112. The node maintenance request can include cluster configurations, workload assignments, and/or node maintenance requests. The node maintenance request may be used to reboot one or more nodes, replace the boot volume of one or more nodes, replace one or more nodes, change the state of one or more nodes, remove computing resources from one or more nodes, and/or attach computing resources to one or more nodes. The node maintenance request may include an indication of a node (e.g., a node identifier) to operate on and/or an indication of a cluster (e.g., a cluster identifier) to operate on. In certain embodiments, a set of nodes may be indicated.

The node maintenance request can be received at the cluster manager 112 via a network 114 and the service provider API 116. The service provider API 116 may determine to transmit the node maintenance request to the cluster manager 112 based on a cluster identifier included in the node maintenance request (e.g., the cluster identifier may identify cluster 102). The network 114 can be any appropriate network such as the internet. The cluster manager 112 can include a mapping of resources to identities (e.g., tenant identifier, cluster identifier, node identifiers, etc.) in some embodiments. The cluster manager 112 may compare a node maintenance request against one or more permissions to determine if the requesting tenant client 110 has permission to perform the requested maintenance action. A cluster configuration can include the number of nodes, the shape of the nodes (e.g., the computing resources that are assigned to each node), the attached resources for each node, etc.

The node maintenance request may specify an identifier. The identifier can include the cluster identifier, a workload identifier, the node identifier, and/or the tenant client identifier. The node maintenance request may be transmitted to the repair manager138 by the service provider API 116 to determine whether to transmit the node maintenance request to the cluster manager 112. In certain embodiments, in response to the node maintenance request, the cluster manager 112 may send the node maintenance request, with the identities, to repair manager 138 of the service provider (e.g., via service provider API 116). The repair manager 138 may query the access manager 140 to determine if the identities (e.g., tenant client identifier) from the node maintenance request has permission to perform the operations associated with the node maintenance request (e.g., associated with the cluster, node, pods, etc. identified by the node maintenance request). The repair manager 138 can indicate whether access to the identified resource is granted and transmit the indication to the cluster manager 112 and/or to the tenant client 110.

The cluster manager 112 can communicate with the nodes 106-108 via an API server 118 (e.g., an API for the container service). For example, the node maintenance request may be transmitted from the controller 104 to the nodes 106-108 via the API server 118. The API server 118 may validate requests, process the requests, and update the control data store 120. The instructions, and any other data for cluster 102 can be stored to control data store 120. The stored data can include any scheduled workloads (e.g., node maintenance requests), the results of any workloads (e.g., a status of a node maintenance request), permissions for the cluster 102, identities, etc. Workloads can be allocated to the nodes 106-108 by the scheduler 122. The state for the nodes, including the shape for each node and any attached resources, can be managed by the controller manager 124.

The controller manager 124 can manage controllers that monitor the cluster and take action when an actual state does not match an expected state. Controllers that the controller manager 124 may manage include, but are not limited to, a node controller that monitors worker nodes and replaces failing ones, a replication controller that ensures the correct number of pod replicas are running, an endpoint controller that manages services and their associated pods, a node action controller that monitors the control data store 120 for node maintenance request to cause the node action controller to manage the node (e.g., cordon, drain, and/or uncordon, etc.), and/or to cause a node operation controller to manage the node and/or compute used by the node. The controller manager 124 may access an expected state for each node 106-108 via the cluster manager 112 or from the control data store 120. The controller manager 124 can monitor the actual state of the nodes 106-108 via the API server 118, and the controller manager 124 can change the actual state of the nodes 106-108 if the actual and expected state differ.

The control data store 120 may store a state of the cluster 102 and the configuration of the cluster 102. The control data store 120 may include a key value store (e.g., a distributed key-value store) that is used to persist cluster 102 data.

The nodes 106-108 and controller 104 can communicate via node agents (e.g., node agents 126 and 128). In some embodiments, the communication can occur via network proxies (e.g., network proxies 130 and 132). The node agents 126 and 128 can change the state of each node, attach or remove computing resources from each node, and assign workloads to each node. A workload can be deployed in a group of one or more containers called a pod. Nodes can have one or more pods (e.g., pod(s) 134 and 136) that are executing on the respective node simultaneously. Pods 134 and 136 can correspond to one or more workloads that are scheduled to be executed on the same computing device in a shared context. The context can include common namespaces, control groups, and computing resources for the one or more workloads within the pod. A workload may be generated based on a node maintenance request.

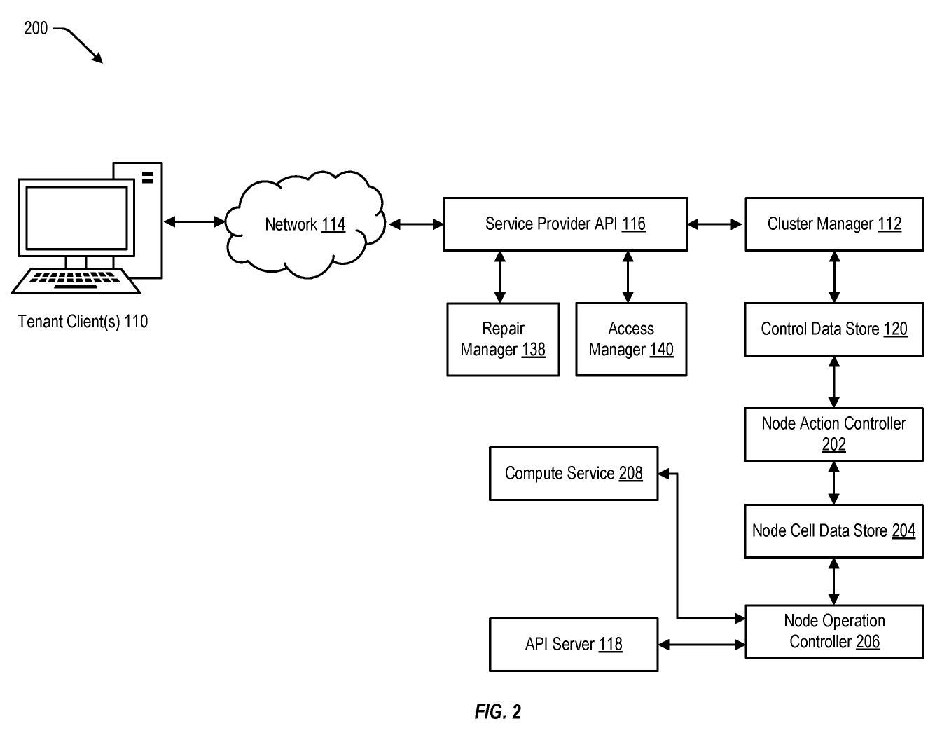

FIG. 2 shows a simplified diagram of a node repair system 200, according to at least one embodiment. The node repair system 200 may be the node repair system 100 described above with respect to FIG. 1. The node repair system 200 may include one or more tenant clients 110 (e.g., tenant clients 110 described above with respect to FIG. 1), a network 114 (e.g., network 114 described above with respect to FIG. 1), a service provider API 116 (e.g., service provider API 116 described above with respect to FIG. 1), a repair manager 138 (e.g., repair manager 138 described above with respect to FIG. 1), an access manager 140 (e.g., access manager 140 described above with respect to FIG. 1), a cluster manager 112 (e.g., cluster manager 112 described above with respect to FIG. 1), a control data store 120 (e.g., control data store 120 described above with respect to FIG. 1), a node action controller 202, a node cell data store 204, a node operation controller 206, an API server 118, (e.g., API server 118 described above with respect to FIG. 1), and a compute service 208.

The control data store 120 may store node maintenance requests or a portion of a node maintenance request received from the cluster manager 112. The node maintenance request may include an identifier of the tenant client 110 the node action maintenance request was received from. The node maintenance request may include an indication of node maintenance to be performed (e.g., a boot volume replacement, a reboot, etc.). The node maintenance request may include a request for a node action. The indication of node maintenance to be performed may indicate whether a node should be cordoned, uncordoned, drained, have resources attached, and/or have resources unattached, etc.

Cordoning the node can mark the node as unschedulable to prevent new pods from being scheduled on the node. Existing pods on the node can continue running. Cordoning the node can prepare the node for maintenance without disrupting current workloads. Uncordoning the node can allow the node to accept new workloads (e.g., used after maintenance is finished).

Draining the node may evict running pods (e.g., all running pods) from the node before marking it as unschedulable. Draining the node can be used to reschedule workloads on other nodes and be used when performing maintenance that required the node to be empty.

The power action on the node may cause the node to shut off, turn on, and/or power cycle. The power action may be used to manage cluster stability, perform maintenance, or recover from failures.

The boot volume replacement can preserve existing storage volume before a node is taken offline for boot volume replacement. The boot volume replacement can be used to enable data to be replicated and available on another node before the node is taken offline.

The node maintenance request may include an indication of the node (e.g., a node identifier, a compute instance identifier) and/or the cluster (e.g., a cluster identifier) the node maintenance should be performed on. The node maintenance requests may be stored in association with a node maintenance request status and an identifier of the node maintenance request. The node maintenance request status may indicate whether the node action controller 202 has transmitted a node action request based on the node maintenance request. The node maintenance request status may indicate a result (e.g., that the node maintenance was performed successfully, that the node maintenance has not been performed yet, that the node maintenance is queued, and/or that the node maintenance could not be performed, etc.) of a node action request transmitted by the node action controller 202 based on the node maintenance request. The identifier of the node maintenance request may be generated to uniquely identify the node maintenance request from other node maintenance requests stored by the control data store 120. The node maintenance requests may have been received from the tenant client 110 via the network 114, service provider API 116, and/or the cluster manager 112.

In certain embodiments, the service provider API 116 call (e.g., the node maintenance request) includes the cluster identifier and/or the node identifier that the node maintenance request is associated with. An example of a node maintenance request includes a request to replace a boot volume or a request to reboot. In certain embodiments, the repair manager 138 may perform validation for the node maintenance request (e.g., before the node maintenance request is stored by the control data store 120, before the node action controller 202 generates a node action request based on the node maintenance request). The validation may include validating the tenant identifier associated with the maintenance request is on an allow list for the maintenance request, validating the cluster identifier is identifies an enhanced cluster (e.g., a cluster that supports receiving the node maintenance request), and/or validating the node identifier included in the node maintenance request is in a format that can be used by node repair system 200. Other validations may include validating that the cluster is not in a terminated or terminating state, validating the node cluster is associated compute controlled by compute service 208, validating there are no other node actions being performed to a node identified by the node maintenance request.

The node action controller 202 may be managed by a controller manager (e.g., controller manager 124 described above). The node action controller 202 may follow a controller-commons with sharding model and registers itself as a listener to the control data store 120. In certain embodiments, the node action controller 202 registers itself as a listener to a bucket of the control data store 120 that includes node maintenance requests (e.g., node actions). The node action controller 202 may find the node maintenance request through searching for entries included in the control data store 120. The node action controller 202 may search for entries, entries associated with a certain node, entries with a specific status, and/or entries with a certain node maintenance request identifier. When the node action controller 202 is informed (e.g., via listening) that there is a node maintenance request added to the control data store 120, node action controller 202 may generate and transmit a node action request to the node cell data store 204 based on the node maintenance request.

The node action request may include the node maintenance request identifier, the indication of node maintenance to be performed, the indication of the node (e.g., the node identifier), and/or the indication of the cluster (e.g., the cluster identifier) the node maintenance should be performed on. In certain embodiments, the node action requests includes an identifier of the node action request which may be different from the identifier of the node maintenance request but be associated with the identifier of the node maintenance request so that the node maintenance status associated with the node maintenance request identifier can be updated based on processing of the node action request. The node cell data store 204 may be one of a plurality of node cell data stores. The node cell data store 204 that the node action request is transmitted to may be determined based on the indication of the node included in the node maintenance request. The node action controller 202 may be associated with the node and be configured to monitor the control data store 120 for maintenance requests associated with the node.

The node cell data store 204 may store the node action request or a portion of the node action request. The node action request may be stored in association with a node action request identifier. The node action request identifier may be the node maintenance request identifier or be associated with the node maintenance request identifier. In certain embodiments, the node action request identifier may be generated to uniquely identify the node action request from other node action requests stored by the node cell data store 204. The node action request may be stored in association with a node action request status. The node action request status may indicate a status of the node action request. The node action request status may indicate whether the node operation controller 206 has transmitted a node operation request based on the node action request. The status of the node action request may indicate an operation result (e.g., that the node action was performed successfully, that the node action has not been performed yet, that the node action is queued, and/or that the node action could not be performed, etc.) of a node operation transmitted by the node operation controller 206.

The node operation controller 206 may be managed by a controller manager (e.g., controller manager 124 described above). The node operation controller 206 may register itself as a listener to the node cell data store 204. In certain embodiments, the node operation controller 206 registers itself as a listener to a bucket of the node cell data store 204 that includes node operation requests. When the node operation controller 206 is informed (e.g., via listening) that there is a node action request added to the node cell data store 204, node operation controller 206 may generate and transmit a node operation request to the API server 118. The node operation request may include the indication of node maintenance to be performed, the indication of a node (e.g., the node identifier), and/or the indication of the cluster (e.g., the cluster identifier) the node maintenance should be performed on. The node operation request may request may include one or more indications of a commands for the node, such as a cordon, drain, and/or uncordon command. The node operation request may indicate whether to perform a boot volume replacement and/or a reboot of the node.

When the node operation controller 206 is informed (e.g., via listening) that there is a node action request added to the node cell data store 204, node operation controller 206 may generate and transmit a compute operation request to the compute service 208. The compute operation request may request a boot volume replacement be performed and/or a power action be performed (e.g., a power cycle, a power on, a power off, etc.).

The API server 118 is described in further detail above and may include a native container API such as a Kubernetes API. Interactions with the cluster (e.g., creating pods, scaling deployments, etc.) may go through the API server 118. The API server 118 may validate requests (e.g., node operation requests), process the node operation requests, and update the control data store 120 (e.g., an etcd, described above).

The compute service 208 may manage cloud provider-specific integrations. The compute service 208 may manage load balancers, persistent storage, and/or node lifecycles (e.g., detecting when a cloud instance is terminated).

The node operation controller 206 may receive an indication from the API server 118 after the API server 118 receives, is completing, has completed, and/or has failed to complete, etc. the node operation request. The node operation controller 206 may receive an indication from the compute service 208 after the compute service 208 receives, is completing, has completed, and/or has failed to complete, etc. the compute operation request.

The node operation controller 206 may update the node action request status stored by the node cell data store 204 based on the indication from the API server 118 and/or the indication from the compute service 208.

The node action controller 202 may poll (e.g., periodically) the node cell data store 204 to check the node action request status stored by the node cell data store 204. The node action controller 202 may update the status of the node maintenance request status stored by the control data store 120 based on the status of the node action request status. The node action controller 202 may update one or more buckets stored by the control data store 120 (e.g., a NodeAction bucket, a WorkRequest bucket, a node state bucket). The WorkRequest bucket (e.g., a node maintenance request status bucket) may be used to report progress of the node maintenance requests. The node state bucket may be used to keep a consistent view from node level and node pool level (e.g., whether a node is terminated, has joined the cluster, etc.).

In certain embodiments, the maintenance request entry stored by the control data store 120 and associated with the node maintenance request status is deleted from the control data store 120 after the request is completed. In certain embodiments, the action request entry stored by the node cell data store 204 and associated with the node action request status is deleted from the node cell data store 204 after the action request is completed. In certain embodiments, the node action controller 202 and/or the node operation controller 206 updates the state of a node associated with the node identifier associated with the node action request and/or node operation request.

In certain embodiments, a node maintenance request may be canceled. The node maintenance request may be canceled based on a cancel request received from the tenant client 110. In embodiments that support canceling a node maintenance request, the cluster manager 112 may update a corresponding node maintenance request status to a canceled status. The control data store 120 may remove the entry from the control data store 120 if the node maintenance request status is changed to canceled. If the node action controller 202 has already generated and transmitted a node action request based on the node maintenance request (e.g., as indicated by a status associated with the node maintenance request and/or and identifier included in the node cell data store 204), the status of the node action request may be updated to a canceled state in the node cell data store 204 to cause the node action request to be canceled (e.g., removing the node action request from the node cell data store 204). If the node operation controller 206 has already generated and transmitted a node operation request based on the node action request and/or a node compute request, a cancel request may be transmitted to the computer service and/or the API server 118 to cancel the request(s).

In certain embodiments, the node maintenance request status is changed to canceled and the above described canceling actions are performed to cancel the node maintenance request if the state of a node has been in a terminal state for more than a predefined period of time (e.g., 20 minutes) because of a timeout.

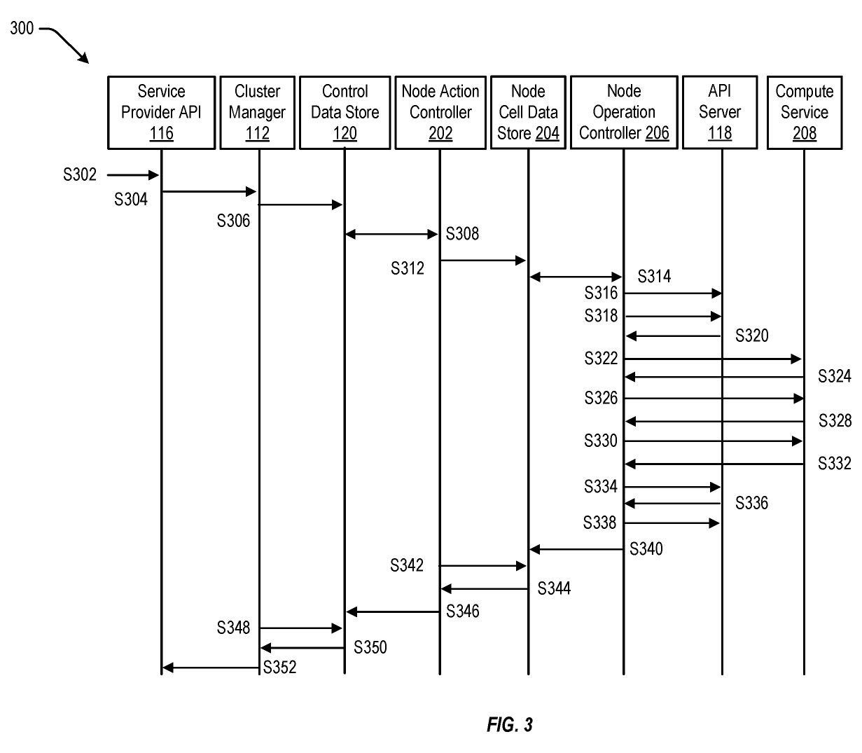

FIG. 3 shows a simplified flow diagram 300 for processing performed by a node repair system (e.g., node repair system 100, node repair system 200), according to various embodiments. The node repair system may include a service provider API 116 (e.g., service provider API 116, described above with respect to FIG. 2), a cluster manager 112 (e.g., cluster manager 112 described above with respect to FIG. 2), a control data store 120 (e.g., control data store 120 described above with respect to FIG. 2), a node action controller 202 (e.g., node action controller 202 described above with respect to FIG. 2), a node cell data store 204 (e.g., node cell data store 204 described above with respect to FIG. 2), a node operation controller 206 (e.g., node operation controller 206 described above with respect to FIG. 2), an API server 118 (e.g., API server 118 described above with respect to FIG. 2), and a computer service 208 (e.g., computer service 208 described above with respect to FIG. 2). The process may be performed for one or more nodes.

At step S302, the service provider API 116 may receive a node maintenance request. The node maintenance request may have been received from the tenant client device (e.g., tenant client 110 described above) via the network 114. The node maintenance request may include an indication of node maintenance to be performed. The node maintenance request may include a node action. The indication of node maintenance to be performed may indicate whether a node should be rebooted, have a boot volume replacement, be cordoned, be uncordoned, be drained, have resources attached, and/or have resources unattached, etc. The node maintenance request may include an indication of the node (e.g., a node identifier) and/or a cluster (e.g., a cluster identifier) the node maintenance should be performed on. The node maintenance request may include a node eviction setting to cordon and/or drain the node to ensure no disruption to the workload during boot volume replacement.

At step S304, the service provider API 116 may transmit the node maintenance request to the cluster manager 112. In certain embodiments, the node maintenance request is received after the service provider API 116 uses a repair manager (e.g., repair manager 138 described above) and/or access manager (e.g., access manager 140 described above) to determine if the node maintenance request should be carried out. For example, the repair manager and/or the access manager may determine the node maintenance request was received from a tenant client or device that has necessary cluster and compute instance permissions.

At step S306, the cluster manager 112 may transmit the node maintenance request to the control data store 120. The node maintenance request may be stored as an entry in a data structure maintained by the control data store 120. The control data store 120 may store the node maintenance requests as described above. In certain embodiments, the cluster manager 112 validates the node is part of the cluster and there is no other in-flight node action (e.g., no other node maintenance requests entries stored in the control data store 120 that are associated with the node) on the same node. Determining whether there is another in-flight node action on the same node may include querying the control data store 120 to determine a status of the node and/or to determine if a maintenance request associated with the node is stored by the control data store 120. Additionally, or alternatively, the cluster manager 112 may perform other validations before transmitting the maintenance request to the control data store 120. Validation may include determining the node exists in compute, determining the node is not terminated, the node belongs to the cluster, the node has not been marked to be deleted. Other validation techniques are described herein.

At step S308, the node action controller 202 may be monitoring the control data store 120 for new entries. The node action controller 202 may determine that step S306 was performed and determine that a node action request should be generated. The node action controller 202 may read and/or request the new node maintenance request entry from the control data store 120. The node action controller 202 may receive the node maintenance request entry from the control data store 120.

At step S312, the node action controller 202 may generate the node action request based on the node maintenance request. The node action controller 202 may transmit the node action request to the node cell data store 204. The node action request may include the node identifier, the cluster identifier, and/or the indication of node maintenance to be performed. The node action request may include an identifier of the node action request as described above.

At step S314, the node operation controller 206 may be monitoring the node cell data store 204 for new entries of node action requests. The node operation controller 206 may determine that step S312 was performed and determine that a node operation request should be generated. The node operation controller 206 may read and/or request the new entry for the node from the node cell data store 204. The node operation controller 206 may receive the new node action request entry from the node cell data store 204.

In certain embodiments, the node action controller may not transmit a node operation request associated with the node to the API server 118 and/or the compute service 208 until a status associated with another node operation request associated with the node indicates that the other node operation requests for the node has been completed or has stopped (e.g., other node action operation may not be performed until the state is in a terminal state).

In certain embodiments, the node operation controller 206 may request a configuration from the node identified by the node operation request generated by the node operation controller 206. The configuration may be represented by a configuration file (e.g., a YAML file). The configuration file may contain configuration parameters and settings that define how the node operated within the cluster. The node operation controller 206 may store the configuration file or cause the configuration file to be stored while the node is being operated on.

At step S316, the node operation controller 206 may generate the node operation request based on the node action request. The node operation controller 206 may transmit the node operation request to the API server 118. The node operation request may include the indication of node maintenance to be performed, the indication of the node (e.g., the node identifier), and/or the indication of the cluster (e.g., the cluster identifier) the node maintenance should be performed on. The node operation request may include one or more commands for a node, such as a cordon and/or a drain command.

At step S318, the node operation controller 206 may generate and transmit a pull request to the API server 118. The pull request may request an eviction status. The eviction status requested may be associated with the node operation request transmitted at step S316. The pull request may be used to check whether the node is cordoned and all eligible pods are evicted. The node operation controller 206 may wait for eviction to be finished until an eviction grace period has elapsed. If eviction does not finish within the grace period, a fail cycling request may be transmitted by the node operation controller 206 to instruct the API server 118 to stop the cycling request. In certain embodiments, the node operation controller 206 may be configured to transmit a boot volume replace command after the grace period elapses if the eviction has not finished. In certain embodiments, the grace period may be defined by the node configuration and/or may be set by the node operation request. The node operation request may include a node grace period that was included in the node action request and/or the node maintenance request. A grace period may be set to a value (e.g., zero) to cause no grace period to occur, causing a boot volume or reboot to occur without a cordon or drain operation first occurring.

At step S320, the API server 118 may transmit a response to the pull request to the node operation controller 206. The response may include an indication of whether the node has been evicted.

At step S322, the node operation controller 206 may generate and transmit a request for compute instance (e.g., node) details. The request may include the node identifier for the node targeted by the request. The node may be the node that the maintenance request is directed toward. The request for the computer instance may be transmitted to the compute service 208 to determine the status of the node maintained by the compute service 208 (e.g., the cloud provider infrastructure).

At step S324, the compute service 208 may determine whether the node is busy or can be worked on. The compute service 208 may transmit a compute instance request response to the node operation controller 206.

At step S326, the node operation controller 206 may generate and transmit a compute operation request to the compute service 208. The compute operation request may request a boot volume replacement be performed using an update instance operation and/or a power action be performed (e.g., a reboot action). The compute operation request may include the identifier of the node so that the compute service 208 can determine which node to perform the compute operation on. The compute service 208 may record a compute work request and wait for the work request to finish before transmitting a response at step S328. The node operation controller 206 may cause the compute service 208 to update a configuration of the node (e.g., provision a bootstrap token to the node so the node can re-register with the API server 118).

At step S328, compute service 208 may generate and transmit a status update related to the compute operation to the node operation controller 206. The node operation controller 206 may use the status update to update the node action request status stored by the node cell data store 204 (e.g., to indicate whether the work request has finished). The status update may indicate whether the work request (e.g., the node action request request) has finished.

At step S330, node operation controller 206 may request a work request status from the compute service 208. The request for the work request status may include the identifier of the compute operation request, the node identifier, and/or the cluster identifier to be used to determine the status of the work request.

At step S332, the compute service 208 may transmit the work status to the node operation controller 206. The status update may indicate whether the work request (e.g., the compute operation request) has finished.

At step S334, the node operation controller 206 may transmit a pull request to the API server 118. The pull request may include a request for node readiness status. A node may be ready if the node has been registered back to the cluster after the node was rebooted or had a boot volume replacement.

At step S336, the compute service 208 may transmit the node readiness status to the node operation controller 206.

At step S338, after the node readiness status is received by the node operation controller 206 and the node readiness status indicates the node is ready. The node operation controller 206 may cause the node to be uncordoned.

At step S340, the node operation controller 206 may transmit a status indication to the node cell data store 204. The node operation controller 206 may cause the node action request stored in the node cell data store 204 to be associated with status that indicates the node has been uncordoned. The node operation controller 206 may repeat steps S316 through S340 until no further node action requests remain in the node cell data store 204 for the node operation controller 206.

At step S342, the node action controller 202 may determine that the status of the node action request has been updated to the status that indicated the node has been uncordoned. The node action controller 202 may make the determination by listening for changes to the node cell data store or by periodically checking for updates to the node action request status.

At step S344, the node action controller 202 may receive the status of the node action request from the node cell data store 204 (e.g., in response to the determination made in step S342, after requesting the status, etc.).

At step S346, the node action controller 202 may transmit the status to the control data store 120 to cause the maintenance request status to be updated in the control data store 120. The updated status may indicate that the maintenance request for the associated node was completed.

At step S348, the cluster manager 112 may determine that the status of the node maintenance request has been updated to the status that indicates the node maintenance request has finished (e.g., with success or failed). The cluster manager 112 may make the determination by listening for changes to the control data store 120 or by periodically checking for updates to the node maintenance request status.

At step S350, the control data store 120 may transmit the status indication for the node maintenance request to the cluster manager 112. The status indication may be transmitted based on a request (e.g., a pull request) made by the cluster manager at step S348.

At step S352, the cluster manager 112 may transmit the status indication of the node maintenance request to the service provider API 116. The service provider API 116 may transmit the status indication to a tenant client or another component that transmitted the node maintenance request at step S302.

Some examples scenarios are described below. In an example, a tenant client submits a node maintenance request to replace boot volume or reboot the node identified by the node maintenance request. The node maintenance request may be submitted to the cluster manager 112 while there is an in-flight node action for the node (e.g., a replace boot volume or reboot node maintenance request already stored by the control data store 120 for the node). The cluster manager 112 may reject the node maintenance request and indicate that the request was rejected because another request associated with the node is already in progress.

In an example, a tenant client submits a node maintenance request (e.g., a replace boot volume request or reboot request) and destructive cycling node pool request. The node maintenance request and the destructive cycling node pool request may be received and accepted by the cluster manager 112. The cluster manager 112 may return two different works requests, that each correspond with the respective request. The node maintenance request and the destructive cycling node pool request may be processed in parallel. If the node indicated by the destructive cycling node pool request is the same node as the node indicated by the node maintenance request, a status of the node maintenance request may have a canceled state assigned by the cluster manager 112 or the node action controller because the node will be gone after the destructive cycling node pool request. If the node indicated by the destructive cycling node pool request is not the same node as the node indicated by the node maintenance request, the node maintenance request may impact node pool capacity, the node action controller may accommodate both of the node maintenance requests store by the control data store 120.

In an example, the tenant client submits a node maintenance request (e.g., a replace boot volume or a reboot) and a non-destructive cycling node pool request. The cluster manager 112 may receive and accept the node maintenance request and the non-destructive cycling node pool request. The cluster manager 112 may insert each of the requests into the control data store 120 and both of the requests can be processed in parallel. If the node identifier with the node maintenance requests is not the same node identified as the non-destructive cycling node pool request, the node action request may impact node pool capacity, the node action controller 202 accommodate both of the node maintenance requests store by the control data store 120.

In an example, a tenant client submits a node maintenance request (e.g., a replace boot volume or a reboot) and a delete node request for the same node. If node deletion request is received by the cluster manager 112 first, the cluster manager 112 may reject node action request. If the node maintenance request is received by the cluster manager 112 first, the node action controller 202 may cancel the node action request and then cause the node to be deleted.

In an example, the tenant client submits a delete node pool request to the cluster manager 112 via the service provider API 116. The cluster manager 112 may may cause all in-flight node actions (e.g., the node maintenance requests) of the nodes in the node pool to be canceled, and then delete the nodes. The in-flight node actions may be caused to be canceled by updating the status of a node maintenance request stored by the control data store and/or updating the status of a node action request stored by the node cell data store 204.

In an example, the tenant client submits a node maintenance request (e.g., to replace boot volume or to perform a reboot) and creates a node pool request. The cluster manager 112 may accept both requests and generate two status indications, each indicating a status of the respective request. The node maintenance request can be processed in parallel with node pool create operation.

In an example, a tenant client submits a node maintenance request (e.g., a request to replace boot volume or perform a reboot) and an update node pool request. The cluster manager 112 may receive the requests via the service provider API 116. The cluster manager 112 may accept both of the requests and transmit the request to the control data store 120. The cluster manager 112 may return the status of each request to the service provider API 116 based on status updated stored in the control data store 120. The node maintenance request can be processed in parallel with the node pool update operation when the node pool update operation does not impact existing nodes. If a node pool update request results in termination of a node, any in-flight node maintenance request for the node may be canceled using techniques as described above.

In an example, a cluster manager 112 detects a change on a node pool for reconciliation while there is an in-flight node maintenance request. If the change indicates a termination of the node, the cluster manager 112 may cancel any in-flight node maintenance request for the node.

Embodiments described offer several benefits. Certain embodiments can enable the node to be maintained while the node maintenance request is being carried out. The node object can persist even though it’s under repair and the node object may seamlessly be joined back with the cluster after the node maintenance request is complete.

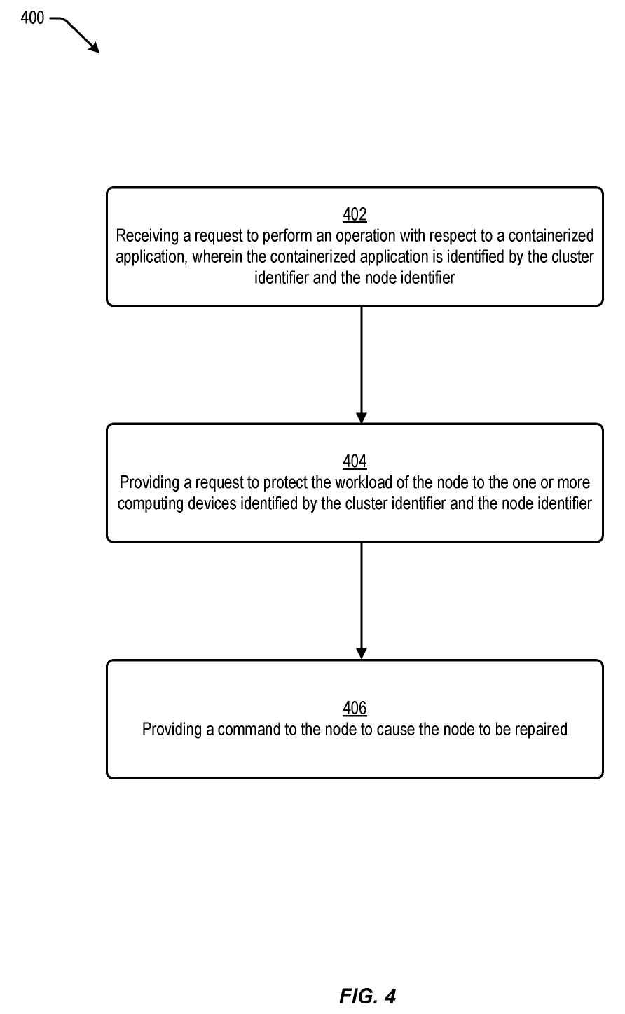

FIG. 4 is a block diagram 400 illustrating an example method (e.g., performed by node repair system 100 or node repair system 200) for repairing a node, in accordance with at least one embodiment.

At step S402, a service provider computer system (e.g., cluster manager 112 described above, a service provider cloud infrastructure running the service provider API 116 described above) may receive a request. The request may include a node maintenance request and may be received via an API (e.g., service provider API 116 described above). The node maintenance request may request the service provider computer system to perform an operation with respect to a containerized application that is executing on one or more computing devices. The request may include a cluster identifier and/or a node identifier that identifies a node. The containerized application may include is one of a plurality of containerized applications that are executing on the one or more computing devices. The containerized application may be identified by the cluster identifier and the node identifier. In certain embodiments, the node identifier can be used to uniquely identify the node. In certain embodiments, the combination of the cluster identifier and the node identifier are used to uniquely identify the node.

At step S404, the service provider computing system may provide a request to protect a workload of the node. The request may be transmitted to the one or more computing device identified by the cluster identifier and/or the node identifier. Protecting the workload of the node may include performing a cordon and/or a drain on the node.

At step S406, the service provider computing system may provide a command to the node to cause the node to be repaired. The command may be provided after the one or more computing devices are caused to protect the workload. The command causing the node to be repaired may cause the node to reboot and/or cause a boot volume replacement for the node.

In certain embodiments a bootstrap token is generated for the node. The bootstrap token may be generated to enable the node to rejoin a cluster identified by the cluster identifier. The token may be generated independent of (e.g., without deleting) the node.

The bootstrap token may be transmitted to the node before the node can rejoin the cluster. The bootstrap token may be transmitted by the service provider computer system to the node. The bootstrap token is described above in further detail. The service provider computing system may provide a second command to cause the node to rejoin the cluster identified by the cluster identifier. The second command may be provided to a compute service (e.g., compute service 208) and the node may be maintained while the node repair is in progress.

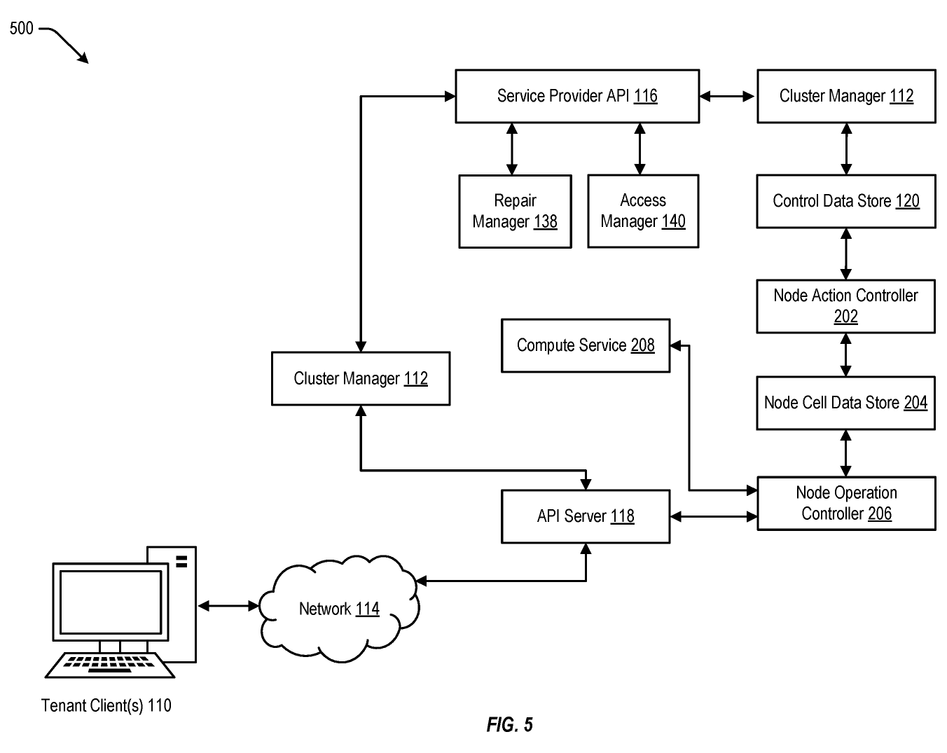

FIG. 5 shows a simplified diagram of a node repair system 500, according to at least one embodiment. The node repair system 500 may include one or more tenant clients 110 (e.g., tenant clients 110 described above with respect to FIG. 2), a network 114 (e.g., network 114 described above with respect to FIG. 2), a service provider API 116 (e.g., service provider API 116 described above with respect to FIG. 2), a repair manager 138 (e.g., repair manager 138 described above with respect to FIG. 2), an access manager 140 (e.g., access manager 140 described above with respect to FIG. 2), a cluster manager 112 (e.g., cluster manager 112 described above with respect to FIG. 2), a control data store 120 (e.g., control data store 120 described above with respect to FIG. 2), a node action controller 202 (e.g., node action controller 220 described above with respect to FIG. 2), a node cell data store 204 (e.g., node cell data store 204 described above with respect to FIG. 2), a node operation controller 206 (e.g., node operation controller 206 described above with respect to FIG. 2), an API server 118, (e.g., API server 118 described above with respect to FIG. 2), and a compute service 208 (e.g., compute service 208 described above with respect to FIG. 2). Components included in the node repair system 500 may operate in a similar manner as described with respect to node repair system 200.

The node repair system 500 may additionally include a node operation rule operator. The node operation rule operator may be included in the cluster manager 112 or managed by the cluster manager 112. For purposes of explanation herein, the node operation rule operator is described with respect to the cluster manager 112.

The cluster manager 112 can watch for changes to a node and a node operation rule object, orchestrate node actions by transmitting node maintenance requests to the service provider API 116, and remove one or more labels from the node after completion of the node maintenance request. The cluster manager 112 may maintain a node operation rule object. The node operation rule object may enable reboot and/or boot volume replacement actions against a set of nodes (e.g., managed nodes, self-managed nodes). The node operation rule object may enable the reboot and/or boot volume replacement actions against the nodes when the nodes are assigned a label that corresponds with the reboot and/or boot volume replacement actions.

The node operation rule object may define one or more actions to take when a label is assigned to a node. As a result, nodes can be labeled and then cause one or more actions to occur based on the label assigned to the node. As an example, the tenant client 110 can cause a node to be labeled using the API server 118, and as a result, cause the node to be rebooted, and/or another action to be performed to the node. The tenant client 110 may be capable of indicating, using the API server 118, a node (e.g., using a node identifier) and a label to be assigned to the node to cause an action to occur.

The action(s) that correspond to a label may be predefined and/or may be configurable. In certain embodiments, the tenant client 110 is capable of transmitting a request to the API server 118 to cause the cluster manager 112 to associate a label with an action so that when a node is assigned the label, the action associated (e.g., corresponding) to the label is performed. In certain embodiments, the API server 118 can be used to configure the node operation rule object to control set an action speed and/or pod eviction settings.

The tenant client 110 (e.g., a container client and/or a Kubernetes client) may transmit, via the API server 118, to the cluster manager 112 a request to remove a label from a node. Removing the label from the node may cause one or more node actions (e.g., one or more node maintenance requests) to be canceled. Canceling node maintenance requests are described above in further detail.

After the node maintenance request is carried out (e.g., is successfully completed), the cluster manager 112 may receive an indication of the successfully completed status of the node maintenance request. Responsive to receiving the successfully completed status, the cluster manager 112 may remove the label from the node. In certain embodiments, a label is assigned to a node and indicates that no maintenance requests associated with the node are pending (e.g., instead of removing a label).

The cluster manager 112 may also watch for changes to the node labels to determine whether to transmit a node maintenance request to the service provider API 116. In certain embodiments, the cluster manager 112 controls a number of node maintenance requests that are performed in parallel. The number of node maintenance requests that may be performed in parallel may be capped based on a setting. The setting may be configured by the tenant client 110 and may apply an entire cluster.

Since certain embodiments may maintain the node object without deleting the node object, labels/taints/annotation of the node can stay intact. Keeping the label of the node intact can enable the cluster manager 112 to use the labels to manage the node and the node maintenance requests.

The cluster manager 112 may transmit a node maintenance request based on the label associated with a node. The node maintenance request may be transmitted to the service provider API 116 and the service provider API 116 may process the node maintenance request as described herein (e.g., with respect to FIGS. 1-4).

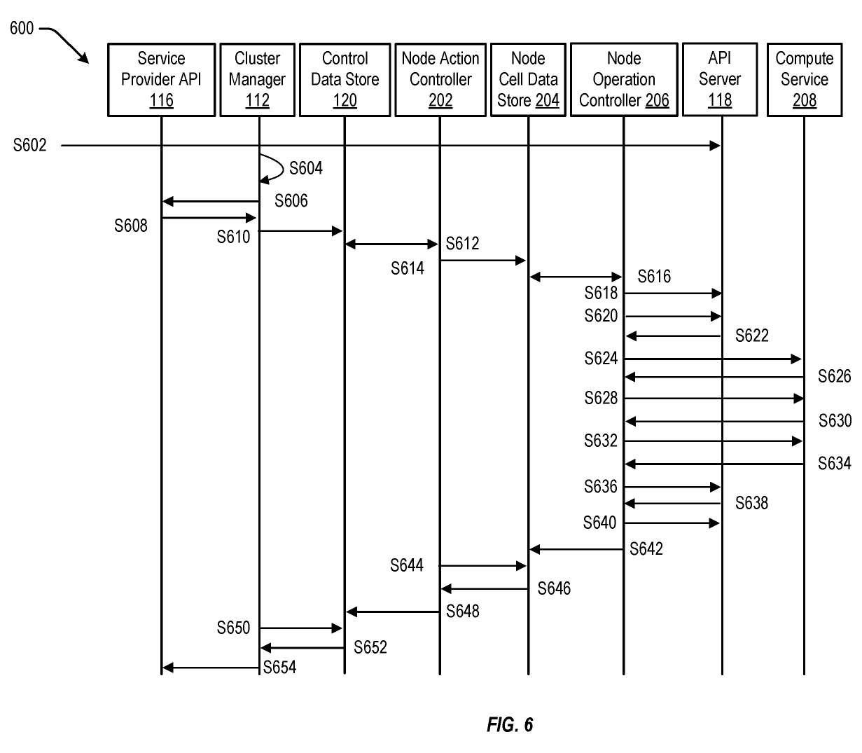

FIG. 6 shows a simplified flow diagram 600 for processing performed by a node repair system (e.g., node repair system 500 described above with respect to FIG. 5), according to various embodiments. The node repair system may include a service provider API (e.g., the service provider API 116 described above), a cluster manager 112 (e.g., the cluster manager 112 described above), a control data store 120 (e.g., the control data store 120 described above), a node action controller 202 (e.g., the node action controller 202 described above), a node cell data store 204 (e.g., the node cell data store 204 described above), controller 206 (e.g., the controller 206 described above), an API server 118 (e.g., the API server 118 described above), a node operation described above), and a compute service 208 (e.g., the compute service 208 described above).

At step S602, the API server 118 may receive a request. The request may be received from a tenant client (e.g., tenant client 110 described above). The request may indicate a node identifier, a cluster identifier, and/or a label to assign to the node identified by the node identifier and the cluster identifier. The API server 118 may cause the node to be labeled. In certain embodiments, the API server 118 updates a label associated with the node identified by the node identifier to be the label included in the request.

At step S604, the cluster manager 112 may watch the nodes of the cluster to determine when a label of one or more nodes changes. The cluster manager 112 may periodically pull the nodes to determine the node labels. In certain embodiments, the cluster manager 112 may be notified after a label of one or more nodes changes.

At step S606, after the cluster manager 112 determines that a node label has changed, the cluster manager 112 may transmit a node maintenance request to the service provider API 116. The node maintenance request may be generated based at least in part on the node, the label, and a node operation rule object used to control actions (e.g., reboots, boot volume replacement, etc.) performed for the node.

The node operation rule object may have been configured by the tenant client 110 to include a set of actions that correspond to a label so that the set of actions (e.g., a repair action) is performed when the label is assigned to the node. The node operation rule object may be updated based on requests received from the service provider API 116 and/or the API server 118.

Step S608-654 may be performed as described with respect to steps S302-352 described above, respectively.

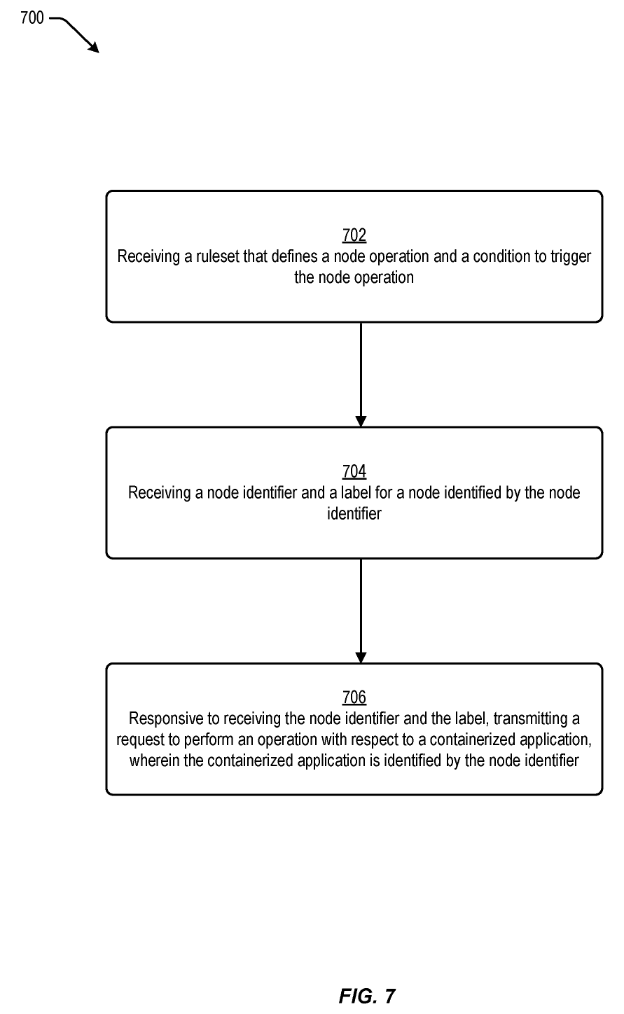

FIG. 7 is a block diagram 700 illustrating an example method (e.g., performed by node repair system 500) for repairing a node, in accordance with at least one embodiment.

At step S702, a cluster management system (e.g., a controller 104, a system running API server 118 described above) may receive a ruleset. The ruleset (e.g., a node operation rule object described above with respect to FIGS. 5 and 6) may define a node operation (e.g., an action) and a condition to trigger the node operation. The node operation may include a at least one of a reboot or a boot volume replacement for the node. The condition may include a label that causes the operation to be performed when the label is associated with the node. The ruleset may be configured by a tenant client (e.g., tenant client 110).

In certain embodiments, the rule set includes a parallelism value indicating a number of maintenance requests capable of being co-pending. The parallelism value can prevent an excessive number of resources from being used. In certain embodiments, the rule set defines a number of nodes that can have at least one of a boot volume replaces or be rebooted in parallel with one or more other nodes. For example, the number may be a maximum number such that the number of nodes being rebooted in parallel cannot exceed the number and resources can be conserved.

At step S704, the cluster management system may receive a node identifier and a label for a node identifier by the node identifier. The cluster management system may receive the node identifier and the label by watching nodes to determine when the label for the node changes. In certain embodiments, the cluster management system node identifier and the label from the API server. In certain embodiments, the cluster management system is configured to manage a single cluster. When the cluster management system is configured to manage a single cluster, the cluster identifier may not be used to identify the node since the node will be included in the single cluster managed by the cluster management system.

At step S706, responsive to receiving the node identifier and the label, the cluster management system may transmit to a service provider system a request (e.g., a node maintenance request) to perform an operation with respect to a containerized application. The service provider system may include the system running a service provider API (e.g., service provider API 116), cluster manager, and/or the cloud service provider infrastructure. The containerized application may be executing on one or more computing devices. The containerized application may be one of a plurality of containerized applications that are executing on the one or more computing devices. The containerized application may be identified by the node identifier.

In certain embodiments, the cluster management system may receive a second request for a set of nodes with a first status from a tenant client. For example, the status may be a node maintenance request status set to a specific value (e.g., in progress, not in progress, finished, failed, etc.). The request may be used to search for nodes that match the first status.

The cluster management system may receive, from the service provider system, the set of nodes with the first status. The set of nodes with the first status may be transmitted to the tenant client. The steps for requesting an obtaining the node maintenance statuses may be useful to a tenant client to determine node statuses. For example, so the tenant client can determine which labels have caused a node operation to be performed, which node operations are queued for which nodes, etc.

In certain embodiments, the cluster management system may receive an indication to remove the label from the node. The indication may be received from the client tenant or the cluster manager (e.g., cluster manager 112 described above in response to the cluster manager determining a node maintenance request has been successfully completed). In response to receiving the request, the cluster management system may transmit to the service provider system, a cancellation request for the node to cause the request to perform the operation to be removed from memory of the service provider system. The request may be removed from the memory of the service provider system as described above.

Any of the computer systems mentioned herein may utilize any suitable number of subsystems. Examples of such subsystems are shown in FIG. 2 in node repair system 200. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

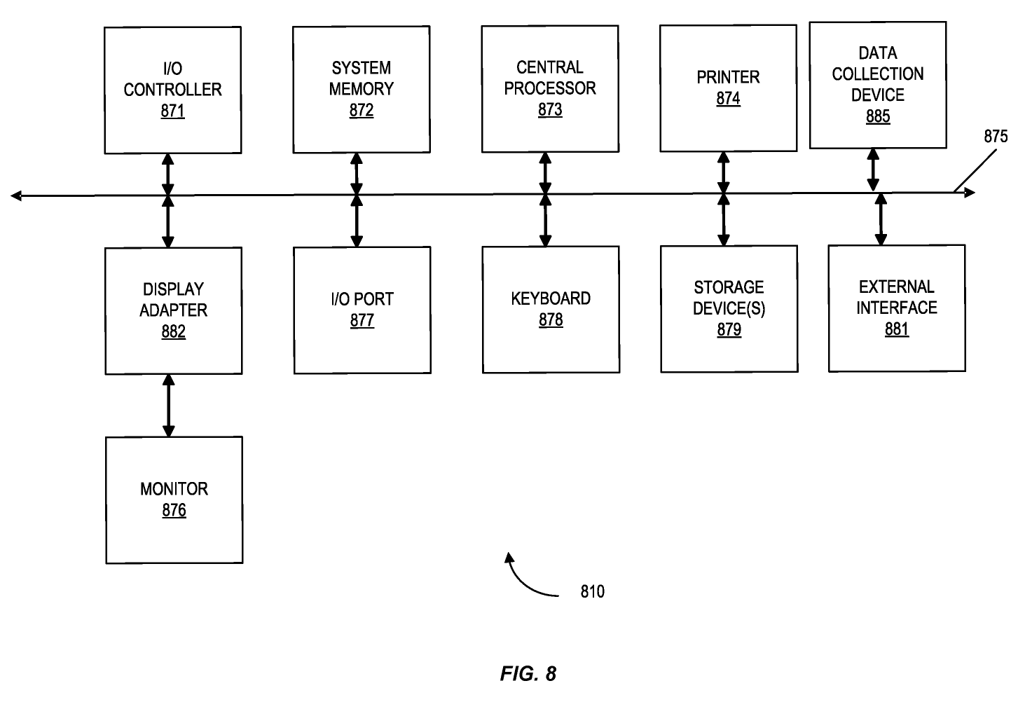

The subsystems shown in FIG. 8 are interconnected via a system bus 875. Additional subsystems such as a printer 874, keyboard 878, storage device(s) 879, monitor 876 (e.g., a display screen, such as an LED), which is coupled to display adapter 882, and others are shown. Peripherals and input/output (I/O) devices, which couple to I/O controller 871, can be connected to the computer system by any number of means known in the art such as input/output (I/O) port 877 (e.g., USB, FireWire^{®}). For example, I/O port 877 or external interface 881 (e.g. Ethernet, Wi-Fi, etc.) can be used to connect computer system 810 to a wide area network such as the Internet, a mouse input device, or a scanner. The interconnection via system bus 875 allows the central processor 873 to communicate with each subsystem and to control the execution of a plurality of instructions from system memory 872 or the storage device(s) 879 (e.g., a fixed disk, such as a hard drive, or optical disk), as well as the exchange of information between subsystems. The system memory 872 and/or the storage device(s) 879 may embody a computer readable medium. Another subsystem is a data collection device 885, such as a camera, microphone, accelerometer, and the like. Any of the data mentioned herein can be output from one component to another component and can be output to the user.

A computer system can include a plurality of the same components or subsystems, e.g., connected together by external interface 881, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

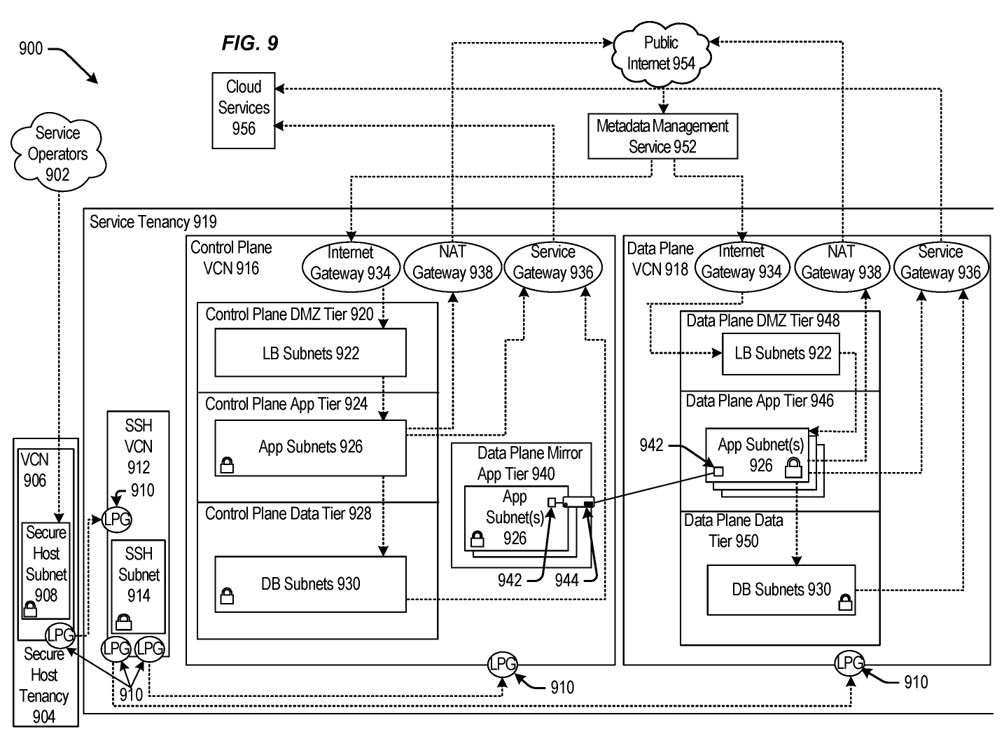

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users’, or other customers’, resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

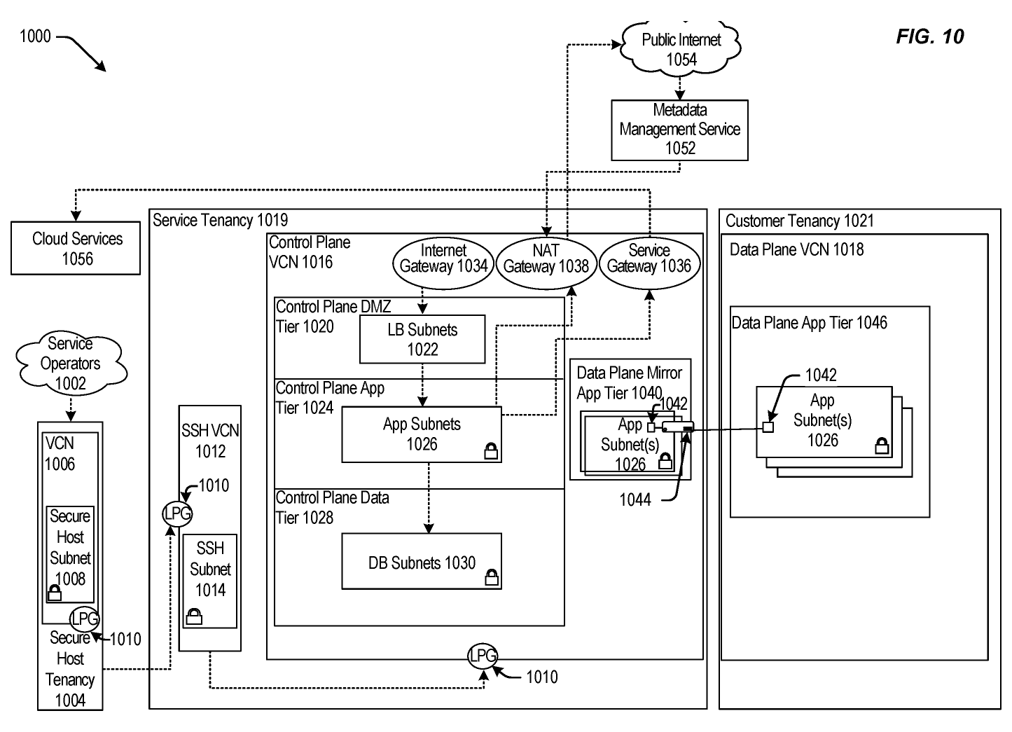

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 9,” may be located in Region 1 and in “Region 2.” If a call to Deployment 9 is made by the service gateway 1036 contained in the control plane VCN 1016 located in Region 1, the call may be transmitted to Deployment 9 in Region 1. In this example, the control plane VCN 1016, or Deployment 9 in Region 1, may not be communicatively coupled to, or otherwise in communication with, Deployment 9 in Region 2.

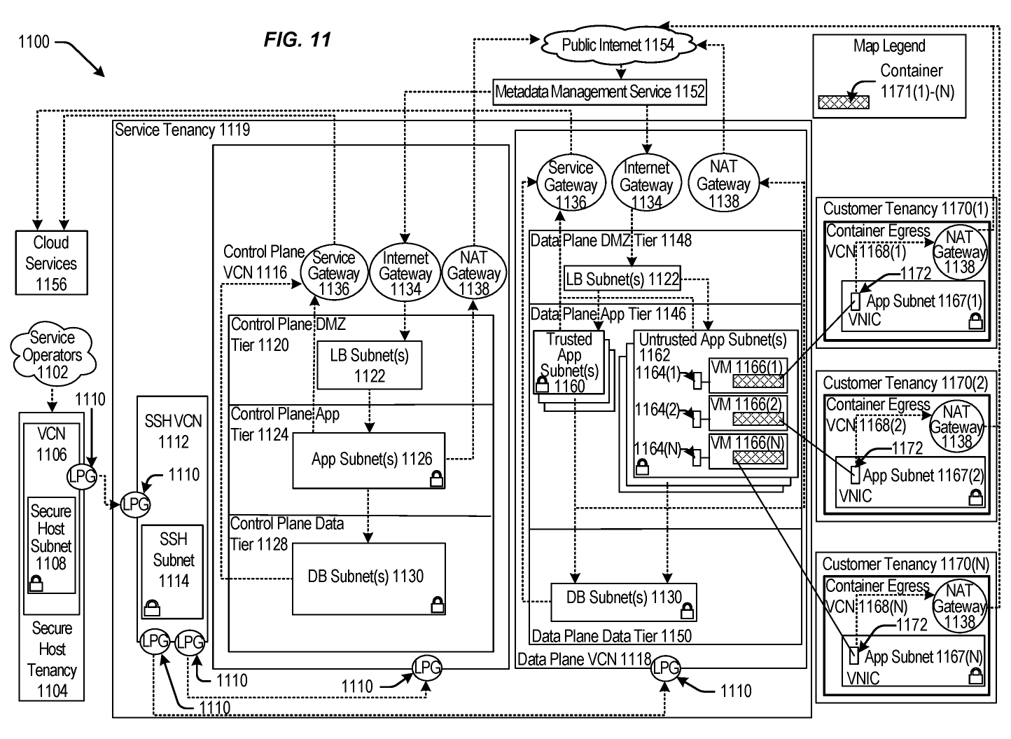

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

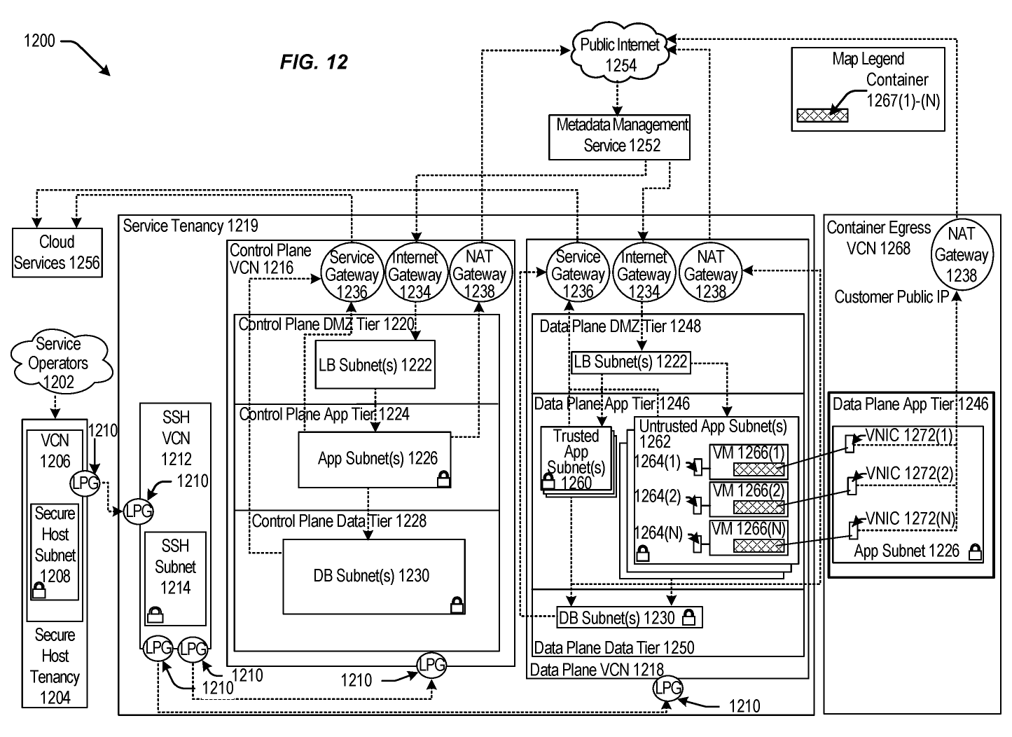

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

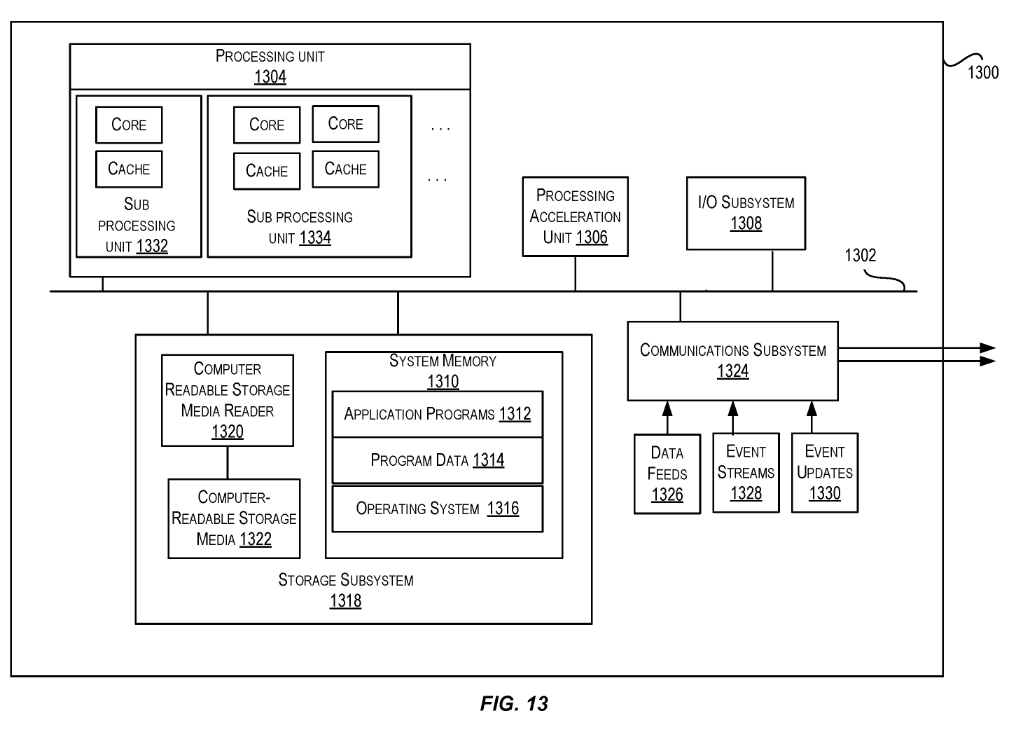

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term "output device" is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, by a cluster management system, a ruleset that defines a node operation and a condition to trigger the node operation;
receiving, by the cluster management system, a node identifier and a label for a node identified by the node identifier; and
responsive to receiving the node identifier and the label, transmitting, by the cluster management system and to a service provider system, a request to perform an operation with respect to a containerized application that is executing on one or more computing devices, wherein the containerized application is one of a plurality of containerized applications that are executing on the one or more computing devices, and wherein the containerized application is identified by the node identifier.

2. The method of claim 1, wherein the ruleset comprises a parallelism value indicating a number of maintenance requests capable of being co-pending.

3. The method of claim 1, wherein the node operation comprises performing at least one of a reboot or a boot volume replacement.

4. The method of claim 1, further comprising:
receiving a second request for a set of nodes with a first status from a tenant client;
receiving, from the service provider system, the set of nodes with the first status; and
transmitting the set of nodes with the first status to the tenant client.

5. The method of claim 1, wherein the ruleset defines a number of nodes that can have at least one of a boot volume replaced or be rebooted in parallel.

6. The method of claim 5, wherein the number of nodes is a maximum number.

7. The method of claim 1, further comprising:
receiving, by the cluster management system, an indication to remove the label from the node; and
transmitting, by the cluster management system to the service provider system, a cancellation request for the node to cause the request to perform the operation to be removed from memory of the service provider system.

8. The method of claim 1, wherein the cluster management system manages a single cluster.

9. A cluster management system comprising:
one or more memories; and
one or more processors in communication with the one or more memories and configured to execute instructions stored in the one or more memories to perform operations comprising:
receiving a ruleset that defines a node operation and a condition to trigger the node operation;
receiving a node identifier and a label for a node identified by the node identifier; and
responsive to receiving the node identifier and the label, transmitting to a service provider system, a request to perform an operation with respect to a containerized application that is executing on one or more computing devices, wherein the containerized application is one of a plurality of containerized applications that are executing on the one or more computing devices, and wherein the containerized application is identified by the node identifier.

10. The cluster management system of claim 9, wherein the ruleset comprises a parallelism value indicating a number of maintenance requests capable of being co-pending.

11. The cluster management system of claim 9, wherein the node operation comprises performing at least one of a reboot or a boot volume replacement.

12. The cluster management system of claim 9, wherein executing the instructions execute stored in the one or more memories causes the one or more processors to perform operations further comprising:
receiving a second request for a set of nodes with a first status from a tenant client;
receiving, from the service provider system, the set of nodes with the first status; and
transmitting the set of nodes with the first status to the tenant client.

13. The cluster management system of claim 9, wherein the ruleset defines a number of nodes that can have at least one of a boot volume replaced or be rebooted in parallel.

14. The cluster management system of claim 13, wherein the number of nodes is a maximum number.

15. The cluster management system of claim 9, wherein executing the instructions execute stored in the one or more memories causes the one or more processors to perform operations further comprising:
receiving an indication to remove the label from the node; and
transmitting, to the service provider system, a cancellation request for the node to cause the request to perform the operation to be removed from memory of the service provider system.

16. A non-transitory computer-readable medium storing a plurality of instructions that, when executed by one or more processors of a cluster management system, cause the one or more processors to perform operations comprising:
receiving a ruleset that defines a node operation and a condition to trigger the node operation;
receiving a node identifier and a label for a node identified by the node identifier; and
responsive to receiving the node identifier and the label, transmitting to a service provider system, a request to perform an operation with respect to a containerized application that is executing on one or more computing devices, wherein the containerized application is one of a plurality of containerized applications that are executing on the one or more computing devices, and wherein the containerized application is identified by the node identifier.

17. The non-transitory computer-readable medium of claim 16, wherein the ruleset comprises a parallelism value indicating a number of maintenance requests capable of being co-pending.

18. The non-transitory computer-readable medium of claim 16, wherein the node operation comprises performing at least one of a reboot or a boot volume replacement.

19. The non-transitory computer-readable medium of claim 16, wherein the instructions executed by the one or more processors cause the one or more processors to perform operations further comprising:
receiving an indication to remove the label from the node; and
transmitting, to the service provider system, a cancellation request for the node to cause the request to perform the operation to be removed from memory of the service provider system.

20. The non-transitory computer-readable medium of claim 16, wherein the instructions executed by the one or more processors cause the one or more processors to perform operations further comprising:
receiving a second request for a set of nodes with a first status from a tenant client;
receiving, from the service provider system, the set of nodes with the first status; and
transmitting the set of nodes with the first status to the tenant client.
